(19) United States
(12) Patent Application Publication
(10) Pub. No.: US 2024/0351935 A1
(43) Pub. Date: Oct. 24, 2024

(54) Hard and Crack-Resistant Glass

(71) Applicant: Rutgers, The State University of New Jersey, New Brunswick, NJ (US)

(72) Inventors: Ashutosh Goel, Hillsborough, NJ (US); Anjali Yadav, North Brunswick Township, NJ (US)

(73) Assignee: Rutgers, The State University of New Jersey, New Brunswick, NJ (US)

(21) Appl. No.: 18/763,605

(22) Filed: Jul. 3, 2024

Related U.S. Application Data
(63) Continuation-in-part of application No. PCT/US22/82349, filed on Dec. 23, 2022.
(60) Provisional application No. 63/266,339, filed on Jan. 3, 2022.

(51) Int. Cl. C03C 3/095; C03C 3/068

(52) U.S. Cl. CPC C03C 3/095; C03C 3/068; C03C 2203/10; C03C 2203/52; C03C 2204/00

(57) ABSTRACT

Disclosed herein is a glass that exhibits high hardness and crack-resistance and can potentially be synthesized using conventional glass manufacturing infrastructure. The glass has high hardness and crack resistance than other commercial glasses. Apart from that, the glass exhibits good glass forming ability and high chemical durability.

### CROSS-REFERENCE TO RELATED APPLICATION

The present application is a Continuation-In Part of International Patent Application Serial No. PCT/US22/82349, filed Dec. 23, 2022, which claims priority under 35 U.S.C. § 119 (e) to U.S. Provisional Patent Application Ser. No. 63/266,339, filed Jan. 3, 2022. The entire contents of these applications are incorporated herein by reference in their entirety.

### TECHNICAL FIELD

Disclosed herein are novel glass compositions with high hardness and higher crack resistance than other commercially available conventional glasses.

### BACKGROUND

Brittleness of glass has been perceived as its gravest handicap. Over the centuries, accepting this handicap and benefitting from optical properties and universal processability, glasses have found their role in applications with low levels of tensile stress.

Glasses with high hardness and crack resistance can find applications in several technological applications. However, it is generally accepted that hardness and crack resistance are inversely proportional to each other. In other words, it is difficult to obtain a “hard” and “crack resistant” glass. For example, a glass designed in the Cs₂O—Al₂O₃—B₂O₃ system when subjected to surface aging under humid conditions can exhibit minimal cracking until 490 N (50 kgf) Vickers load. However, the glass exhibits a Vickers hardness of only 2.0 GPa. Similarly, Asahi's low-brittleness (LB) glass has a crack resistance of approximately 30 N, when measured in N₂. However, its hardness is ≤5 GPa. On the other hand, most of the glasses with high Vickers hardness, for example, ≥7 GPa, exhibit cracking at ≥1.96 N (200 gf) Vickers load.

Some other reported procedures have little practical implications because of the narrow glass forming region and high temperatures (>1800° C.) required to synthesize this glass. Because of this constraint, the as synthesized glasses can only be produced in small shape and dimensions (for example, circular discs of few millimeters in diameter). It is therefore desirable to identify glass compositions that are intrinsically resistant to formation of cracks without losing the hardness. It is further desired that such glasses be scalable into the desired shapes and sizes and manufactured under a cost-effective manner.

### SUMMARY

This document discloses novel glass compositions with desirable hardness and crack resistance for various applications. An aspect of the disclosure provides a glass composition comprising a rare earth metal oxide, magnesium oxide, aluminum oxide, boron oxide, and silicon oxide, wherein the silicon oxide is present in an amount ranging from about 10% to about 50% by mole in the total amount of the oxides and wherein the molar ratio of magnesium oxide to aluminum oxide (MgO:Al₂O₃) in the starting material is less than 1.

In some embodiments, silicon oxide ranges from about 15% to about 35% by mole in the glass composition. In some embodiments, boron oxide ranges from about 5% to about 40% by mole. In some embodiments,

$${N}_{3} [ {N}_{3} = ( \frac{B {O}_{3}}{B {O}_{3} + B {O}_{4}} ) ]$$

is equal or greater than 85%.

In some embodiments, the aluminum oxide is present in an amount ranging from about 30 mol % to about 45 mol %. In some embodiments, at least 30% of the aluminum oxide is in five-coordination (AlO₅). In some embodiments, the rare earth metal oxide is yttrium oxide, lanthanum oxide, or a combination thereof, wherein the rare earth metal oxide ranges from about 5% to about 15% by mole. In some embodiments, alkaline-earth oxide is magnesium oxide, calcium oxide, or a combination thereof ranges from about 5% to about 15% by mole. In some embodiments, the mole ratio between the aluminum oxide and the total of the alkaline-earth oxide and the rare earth metal oxide is equal or greater than 1.

In some embodiments, the amounts of each of the oxides are selected so that the glass composition has a density ranging from about 2.50 to about 3.50 g/cm³. In some embodiments, the amounts of each of the oxides are selected so that the glass composition has a coefficient of thermal expansion (CTE) ranging from about 5.0 to about 6.0 ppm/K. In some embodiments, the amounts of each of the oxides are selected so that the glass composition has a transmission of equal or greater than 80% from a sample of thickness ranging from about 1 mm to about 2 mm. In some embodiments, the amounts of each of the oxides are selected so that the glass composition has Young's modulus ranging from about 90 GPa to about 140 GPa. In some embodiments, the amounts of each of the oxides are selected so that the glass composition has Poisson's ratio ranging from about 0.20 to about 0.40. In some embodiments, the amounts of each of the oxides are selected so that the glass composition has a refractive index ranging from about 1.40 to about 1.80. In some embodiments, the amounts of each of the oxides are selected so that the glass composition has a Vickers hardness of equal or greater than 7.0 GPa at 1.96 N (200 gf) load. In some embodiments, the amounts of each of the oxides are selected so that the glass composition has a crack resistance equal to or greater than 25 N (˜2.55 kgf), wherein the crack resistance corresponds to the load at which 50% crack probability is recorded.

Another aspect of the disclosure provides an article of manufacture containing the composition described herein.

Another aspect of the disclosure provides a method of manufacturing the composition described herein. The method includes (a) heating at a temperature ranging from about 1300 to about 1700° C. a mixture comprising a rare earth metal oxide, magnesium oxide, aluminum oxide, boron oxide, and silicon oxide to obtain a melt, wherein silicon oxide is present in an amount ranging from about 10% to about 50% by mole in the total amount of the oxides; and (b) quenching the melt. In some embodiments, the temperature ranges from about 1400 to about 1700° C.

In some embodiments, the method further includes quenching the melt between two metallic plates or quenching by jet of compressed air. In some embodiments, the method further includes annealing the melt at temperatures above, below or equal to its glass transition temperature.

### DETAILED DESCRIPTION

Novel crack and damage resistant glass composition for various applications is disclosed. The manufacturing of the composition requires only mild conditions, which are suitable to produce articles of different dimensions and shapes.

The articles “a” and “an” as used herein refers to “one or more” or “at least one,” unless otherwise indicated. That is, reference to any element or component of an embodiment by the indefinite article “a” or “an” does not exclude the possibility that more than one element or component is present.

The term “about” as used herein refers to the referenced numeric indication plus or minus 10% of that referenced numeric indication.

The needs of industry for more damage resistant articles and devices are met using the glass comprising the composition disclosed herein. The composition possesses certain advantages such as improved damage/crack and hardness over other commercially available glass or glass ceramic materials.

One aspect provides a glass composition including a rare earth metal oxide, magnesium oxide, aluminum oxide, boron oxide, and silicon oxide. By selecting suitable amounts of the oxides, the glass exhibits an enhanced glass-forming ability, superior crack resistance and chemical durability and less coloration. In one embodiment, the levels of magnesium oxide and aluminum oxide are selected in the starting material so the molar ratio (MgO:Al₂O₃) is less than 1. In another embodiment, the starting material includes MgO and Al₂O₃ present in a molar ratio of less than 1 and a high ionic field strength cation (e.g., Y³⁺) that forces the formation of AlO₅ units.

In some embodiments, silicon oxide is present in an amount ranging from about 5% to about 50%, from about 10% to about 50%, from about 10% to about 40%, from about 15% to about 35%, from about 15% to about 30%, or from about 20% to about 35% by mole in the total amount of the oxides. Non-limiting examples of the amount of silicon dioxide in the total amount of the oxides include about 10%, about 15%, about 20%, about 25%, about 30%, about 35%, and about 40% by mole.

Compositions containing boron oxide often exhibit lower atomic packing density. This may be helpful in lowering the brittleness of glass. In addition, it is a component which acts as a flux to lower the viscosity and thereby facilitate melting of the glass. Materials containing B₂O₃ or serving as a source/precursor (e.g., H₃BO₃) can be prepared in situ or obtained from commercial sources. In some embodiments, boron oxide ranges from about 5% to about 50%, from about 10% to about 40%, from about 12% to about 32%, from about 15% to about 35%, from about 20% to about 30%, or from about 10% to about 20% in the total molar amount of the metal oxides. Non-limiting examples of the amount of boron oxide in the total amount of the oxides include about 5%, about 8%, about 10%, about 12%, about 15%, about 18%, about 20%, about 25%, about 30%, and about 35% by mole. In some embodiments, N₃ is equal or greater than 75%, equal or greater than 80%, equal or greater than 85%, equal or greater than 90% or equal or greater than 95% wherein N₃ is defined as follows:

$${N}_{3} = ( \frac{B {O}_{3}}{B {O}_{3} + B {O}_{4}} )$$

Aluminum oxide plays an important role in the hardness and damage resistance of the glass composition as has been shown in the recent literature [Januchta et al., J. Non-Cryst. Solids 460 (2017) 54; Januchta et al., Chem. Mater. 29 (2017) 5865-5876]. In some embodiments, the content of aluminum oxide ranges from about 20 mol % to about 60 mol %, from about 30 mol % to about 60 mol %, from about 25 mol % to about 55 mol %, from about from about 30 mol % to about 50 mol %, from about from about 30 mol % to about 45 mol %, from about from about 35 mol % to about 45 mol %, or from about from about 30 mol % to about 40 mol %, all sub-ranges and sub-values included, of the total molar amount of the all the metal oxides in the composition. Nonlimiting examples of the amount of aluminum oxide in the total amount of the oxides include about 5%, about 8%, about 10%, about 12%, about 15%, about 18%, about 20%, about 25%, about 30%, and about 35% by mole. In some embodiments, at least 30%, at least 35%, at least 40%, at least 45%, at least 50%, at least 60%, at least 70%, at least 80% or at least 90% of the aluminum oxide is in five-coordination (AlO₅).

Aluminum oxide can be prepared through known reaction procedures or obtained from any commercial sources. Materials containing Aluminum oxide include for example, bauxite (including both natural occurring bauxite and synthetically produced bauxite), calcined bauxite, hydrated aluminas (e.g., boehmite, and gibbsite), aluminum, Bayer process alumina, aluminum ore, gamma alumina, alpha alumina, aluminum salts, aluminum nitrates, and combinations thereof. Alternatively, the aluminum oxide source may contain, or provide aluminum oxide, as well as one or more metal oxides other than aluminum oxide (including materials of or containing complex Al₂O₃.metal oxides (e.g., Dy₃Al₅O₁₂, Y₃Al₅O₁₂, CeAl₁₁O₁₈, etc.).

Rare earth metal oxide, owing to its high ionic field strength, tends to increase the fraction of five-coordinated aluminum, which helps in achieving the high hardness in the glasses. Also, they increase the refractive index and Young's modulus of glasses. Non-limiting examples of rare-earth metal oxides include the oxides of Y, and La. In some embodiments, the rare earth metal oxide is Y₂O₃, La₂O₃, or any combination thereof. The rare earth metal oxide or a combination of the rare earth metal oxide range for example from about 1 mol % to about 30 mol %, from about 5 mol % to about 20 mol %, from about 5 mol % to about 15 mol %, from about 5 mol % to about 10 mol % % of the total molar amount of the metal oxides.

The glass composition also contains an oxide of an alkaline earth metal. In some embodiments, the oxides of alkaline earths include MgO, CaO, or a combination thereof. The alkaline-earth cations, specially, MgO have been shown to lower the brittleness of glasses. Also, both MgO and CaO are known to induce the conversion of four-coordinated aluminum to five-coordination and four-coordinated boron to three-coordination in the glass structure. These structural features are desired to achieve a glass with high hardness and crack resistance. In some embodiments, the composition includes 1, 2, 3, or 4 alkaline earth metal oxides. In some embodiments, the alkaline earth metal oxide in the composition is MgO. The amount of the alkaline earth metal oxide ranges for example from about 2 mol % to about 25 mol %, from about 5 mol % to about 20 mol %, from about 5 mol % to about 15 mol %, or from about 10 mol % to about 15 mol % of the total molar amount of the metal oxides. The ratio by mole between aluminum oxide and the total of the alkaline earth metal oxide and rare earth metal oxide can also impact the properties of the composition. In some embodiments, the ratio is equal or greater than 1, equal or greater than 1.2, equal or greater than 1.4, equal or greater than 1.5, equal or greater than 1.7, or equal or greater than 2.0.

In comparison with many other glasses reported in literature, the glass composition disclosed herein is superior in terms one or more properties of density, coefficient of thermal expansion (CTE), transmission (at for example 1 mm-2 mm sample thickness), Young's modulus, Poisson's ratio, refractive index, Vicker's hardness, and crack resistance. In some embodiments, the amounts of each of the oxides are selected so that the glass composition has a density ranging from about 2.50 to about 3.50, from about 2.80 to about 3.20 or from about 2.90 to about 3.10 g/cm³. Nonlimiting examples of the density of the glass include about 2.85, about 2.90, about 2.95, about 3.00, about 3.05, about 3.10, and about 3.20 g/cm³. In some embodiments, the amounts of each of the oxides are selected so that the glass composition has a coefficient of thermal expansion (CTE) ranging from about 4.0 to about 8.0, from about 5.0 to about 7.0 or from about 5.0 to about 6.0 ppm/K. In some embodiments, the amounts of each of the oxides are selected so that the glass composition has a transmission of equal or greater than 80%, equal or greater than 85%, equal or greater than 88%, equal or greater than 90%, equal or greater than 92% or equal or greater than 95% for a sample thickness ranging for example between about 1 mm and about 2 mm. In some embodiments, the amounts of each of the oxides are selected so that the glass composition has Youngs modulus ranging from about 90 to about 150, from about 100 to about 140, from about 100 to about 120, from about 110 to about 120 GPa. In some embodiments, the amounts of each of the oxides are selected so that the glass composition has Poisson's ratio ranging from about 0.20 to about 0.50, from about 0.20 to about 0.40, from about 0.20 to about 0.30, from about 0.25 to about 0.30 or from about 0.25 to about 0.35. In some embodiments, the amounts of each of the oxides are selected so that the glass composition has a refractive index ranging from about 1.40 to about 1.80, from 1.40 to about 1.70, from about 1.50 to about 1.70, from about 1.50 to about 1.65 or from about 1.55 to about 1.65. In some embodiments, the amounts of each of the oxides are selected so that the glass composition has a Vickers hardness of equal or greater than 7.0, equal or greater than 7.5, equal or greater than 8.0, equal or greater than 8.5, or equal or greater than 9.0 GPa at 100 gf load or 200 gf load. In some embodiments, the amounts of each of the oxides are selected so that the glass composition has a crack resistance equal or greater than 20 N or 2.0 kgf, equal or greater than 25 N or 2.55 kgf, equal or greater than 28 N or 2.8 kgf, equal or greater than 30 N or 3.06 kgf, or equal or greater than 35 N or 3.57 kgf wherein the crack resistance corresponds to the load at which 50% crack probability is recorded.

The composition can also include P₂O₅ ranging from about 0 mol % to about 10 mol %. In some embodiments, P₂O₅ ranges from about 1 mol % to about 5 mol %, from about 2 mol % to about 5 mol %, or from about 1 mol % to about 3 mol % of the total molar amount of the metal oxides.

In some embodiments, the composition further contains TiO₂ ranging from 0 mol % to 10 mol % of the total molar amount of the metal oxides. In one embodiment, when TiO₂ is absent in the composition (0 mol %), the glass composition exhibits an optical transmittance in the wavelength region of 200 nm-2400 nm of 90.2±2%. In some embodiments, the composition further contains Nb₂O₅ or Ta₂O₅ or mixture of both ranging from 1 mol % to 10 mol % of the total molar amount of the metal oxides.

The composition may further contain additional components depending on the specific applications of the glass or glass ceramic product. In some embodiments, the composition further includes one or more alkali metal oxides such as potassium oxide and lithium oxide. The composition may contain components including a coloring component, a ceramic filler and/or a heat resistant pigment. Examples of said other components include a coloring component such as Fe₂O₃ and NiO. Examples of the heat resistant pigment include a Cu—Cr—Mn—O type heat resistant black pigment, a Cu—Cr—O type heat resistant black pigment, a Co—V—Fe—O type heat resistant violet pigment, a Cr—O type heat resistant green pigment and a Co—O type heat resistant green pigment.

Depending on the intended application, the glass composition can be in the form of glass-ceramics. Glass-ceramics can be formed using the same processes that are applicable to glass. To convert them from a vitreous glass material into a vitro-crystalline glass-ceramic material, glass either needs to be heat treated above its glass transition temperature, or the melt needs to be cooled slowly to induce nucleation and crystal growth.

Another aspect provides an article of manufacture containing the composition described herein, which are of great application in many fields such as medical, optics, sports, military, aerospace, wearable fabrics, and energy applications. Advantages of the composition described herein include various desirable mechanical properties as well as low-cost manufacturing and adaptability. The materials made from the composition can be in any form or size as needed such as particles, beads, fibers, sheets, blocks, etc. Articles containing the composition described herein include, for example, reinforcement material, and/or matrix material. For example, glass or glass ceramics made according to the present invention can be in the form of particles and/or fibers suitable for use as reinforcing materials in composites (e.g., ceramic, metal, or polymeric (thermosetting or thermoplastic). The particles and/or fibers may, for example, increase the modulus, heat resistance, wear resistance, and/or strength of the matrix material. Examples of uses of the composition in reinforced polymeric materials (i.e., reinforcing particles made according to the present invention dispersed in a polymer) include protective coatings, for example, for concrete, furniture, floors, roadways, wood, wood-like materials, ceramics, and the like, as well as anti-skid coatings and injection molded plastic parts and components. Further examples include transparent armor, safety glass, and substrate glass or display glass in electronic devices.

The composition can also be used as a matrix material. Examples of useful articles comprising such materials include composite substrate coatings, cutting tool inserts abrasive agglomerates, and bonded abrasive articles such as vitrified wheels, transparent armor in defense automobiles, and electronic packaging.

Another aspect of the document provides a method of manufacturing the above-described composition. The process for preparing the compositions typically includes a number of different steps. Generally, a batch of oxide mixture with a predetermined amount of individual oxide is melted. Batches can be prepared from inexpensive, readily available raw materials such as sand, soda ash, potash, fluorspar, and magnesia, which can be formed into a powder using any suitable technique such as milling or grinding in a mortar. An oxide can be directly blended into the mixture. Alternatively, an oxide can be obtained by heating a precursor to its decomposition temperature in order to remove any water or gases. For example, MgO can be derived in situ from carbonates, nitrates or any other source of magnesium under heating. Similarly, H₃BO₃ is a suitable precursor for B₂O₃. In some embodiments, the mixture comprises a lanthanide oxide, aluminum oxide, and boron oxide. In some embodiments, the mixture comprises a lanthanide oxide, aluminum oxide, boron oxide, and an alkaline earth metal oxide. In some embodiments, the oxides in the mixture consists essentially of a lanthanide oxide, aluminum oxide, and boron oxide. In some embodiments, the oxides in the mixture consists essentially of a lanthanide oxide, aluminum oxide, boron oxide, and an alkaline-earth metal oxide. In some embodiments, the mixture comprises aluminum oxide, one, two or three alkaline earth metal oxide, and optionally silicon dioxide. The amount of each individual oxide is as described above for the composition. In some embodiments, the manufacturing process employs a melt-quench technique to obtain a monolith, which can facilitate the increase of aluminum oxide concentration in the glass or glass ceramics composition.

Melting can be brought about by heating the pre-determined composition to about 1300 to about 1700° C. for a suitable amount of time. For example, the predetermined composition can be placed in a crucible and heated in an electric furnace. Exemplary ranges of the temperature include from about 1400 to about 1700° C., from about 1500 to about 1700° C., from about 1600 to about 1700° C. In some embodiments, the heating lasts for about 1, 3, 5, 7, or 10 hours.

The obtained melt is then transferred to a container, plate or substrate for quenching and further processing into a desired shape and size. In some embodiments, melted composition (i.e., the melt) is then poured into a mold (e.g., a graphite or a metallic mold) to provide a desired shape, after which the melt is furnace-cooled to room temperature to provide a glass. In some embodiments, the melt is splat quenched between two plates to obtain transparent and/or amorphous glasses. In some embodiments, the melt is poured on a plate, or a mold followed by annealing at temperature close to its glass transition temperature.

The composition can be subjected to heat treatment to cause crystallization and/or convert the glass to a glass ceramic. The heat treatment can include reheating of the glass in a variety of different ways. For example, the glass can be reheated to a single temperature from about 500° C. to about 1000° C. for a period sufficient to cause the growth of crystals in situ. Alternately, the glass can be heat treated for a time at a first temperature, and then heat treated for an additional period at a second, higher temperature. The periods of heating can have various durations from about 1 to about 5 hours, and the heat can be changed from the first temperature to the second temperature at a rate from about 1° C./min to about 30° C./min. The first heat treatment step can be carried out at a temperature from about 700° C. to 850° C., with a temperature of about 800° C. being preferred. The second heat treatment step can be carried out at a temperature from about 825 to about 950° C., with a range from about 850 to about 925° C. being preferred. Multi-step heating can be applied if necessary. It is understood by those skilled in the art that the first heat treatment step provides nucleation, while the second heat treatment step provides crystal growth on the earlier formed nuclei, and that crystallization is typically more uniform and fine-grained if the heat treatment of the glass is undertaken in two stages.

The initial batch of oxide mixture may include one or more additional components. Alternatively, the additional component can be added at any stage of the manufacturing process.

### EXAMPLES

### Example 1: Glass Compositions

Table 1 provides examples of glass composition comprising MgO, Y₂O₃, Al₂O₃, B₂O₃, and SiO₂.

TABLE 1
Example glass compositions disclosed in the present invention

| Sample | MgO | Y₂O₃ | Al₂O₃ | B₂O₃ | SiO₂ |
|---|---|---|---|---|---|
| #1 | 10.0 | 9.6 | 34.9 | 15.5 | 30 |
| #2 | 10.0 | 9.6 | 34.9 | 25.5 | 20 |
| #3 | 10.0 | 9.6 | 33.0 | 30.5 | 16.9 |

### Example 2: Optical Transmittance and Physical Properties of Sample #1

The refractive index of sample #1 was measured using a Metricon Model 2010/M Prism Coupler with an accuracy of ±0.0002. The optical transmittance of the glass in the wavelength region of 200 nm-2400 nm was measured on samples with thickness varying between 200 μm-800 μm using an automated reflectance and transmittance measurement system (LAMBDA 950; Perkin Elmer). The data presented herein is an average of measurements taken on at least three different samples.

Table 2 compares sample #1 of the present invention with other commercial glasses in terms of Bulk modulus, Young's modulus, Shear modulus, Poisson's ratio, Refractive index, density, hardness, and indentation crack resistance. The glass transition temperature (onset) of sample #1 is 766±7° C., while its density and refractive index are 3.005±0.003 g/cm³ and 1.636±0.001, respectively (Table 2). The optical transmittance of the glass in the wavelength region of 200 nm-2400 nm is 90.2±2%, which is comparable to that known for commercial glass.

TABLE 2
Comparison of physical, elastic, and mechanical properties of several commercial and non-commercial oxide glasses with sample #1.

| | Bulk | Young's | Shear | | | | Vicker's | Indentation |
|---|---|---|---|---|---|---|---|---|
| | modulus | modulus | modulus | Poisson's | Refractive | Density | Hardness | Crack |
| Glass | (GPa) | (GPa) | (GPa) | ratio | index | (g/cc) | (GPa) | Resistance (N) |
| Sample #1 | 88.70 ± 0.24 | 112.56 ± 0.37 | 43.68 ± 0.19 | 0.288 ± 0.001 | 1.640 ± 0.001 | 3.005 ± 0.003 | 7.84 ± 0.047 | 26.5 |
| Pyrex | 34.00 ± 0.47 | 61.02 ± 0.52 | 25.41 ± 0.36 | 0.200 ± 0.070 | 1.475 ± 0.002 | 2.216 ± 0.001 | 5.96 ± 0.046 | 4.0 |
| Starphire | 43.22 ± 0.25 | 71.48 ± 0.23 | 29.19 ± 0.11 | 0.224 ± 0.002 | 1.525 ± 0.003 | 2.496 ± 0.002 | 5.74 ± 0.036 | 2.7 |
| Borofloat ®33 | 35.5 | 64.0 | 26.7 | 0.20 | 1.471 | 2.23 | 5.51 | 6.9 |
| Silica | 36.7 | 72.0 | 31.2 | 0.17 | 1.470 | 2.20 | 7.30 | 2.9 |
| Eagle ®XG | 45.4 | 73.6 | 30.1 | 0.23 | 1.598 | 2.38 | 6.27 | — |
| Cs—Al—B | 13.3 | 20.0 | 8.0 | 0.25 | — | 2.89 | 2.00 | 30.0 |
| Lion Glass* | ~41.5 | ~60.3 | ~24.0 | ~0.26 | — | ~2.74 | 4.37-5.62 | 0.98−>9.8 |

*Lion Glass is a multicomponent phosphate glass.
All the properties of glass #1 have been experimentally measured.
Silica and Pyrex were bought from McMaster-Carr. The reported properties were measured experimentally.
Starphire glass was synthesized in the laboratory using the composition disclosed in the reference: Wereszczak and Anderson Jr., Int. J. Appl. Glass Sci. 5 (2014) 334-344. All the properties reported here were measured experimentally.
The properties of Eagle ® XG glass reported here have been obtained from the product information sheet provided on Corning ® website.

It will be appreciated by persons skilled in the art that compositions described herein are not limited to what has been particularly shown and described. Rather, the scope of the compositions is defined by the claims which follow. It should further be understood that the above description is only representative of illustrative examples of embodiments. The description has not attempted to exhaustively enumerate all possible variations. The alternate embodiments may not have been presented for a specific portion of the composition and may result from a different combination of described portions, or that other un-described alternate embodiments may be available for a portion, which is not to be considered a disclaimer of those alternate embodiments. It will be appreciated that many of those un-described embodiments are within the literal scope of the following claims, and others are equivalent.

1. A glass composition comprising a rare earth metal oxide, magnesium oxide, aluminum oxide, boron oxide, and silicon oxide, wherein the silicon oxide is present in an amount ranging from about 10% to about 50% by mole in the total amount of the oxides, and wherein the molar ratio of magnesium oxide to aluminum oxide in the starting material (MgO:Al₂O₃) is less than 1.

2. The glass composition of claim 1, wherein the silicon oxide ranges from about 15% to about 35% by mole.

3. The glass composition of claim 1, wherein the boron oxide ranges from about 5% to about 40% by mole.

4. The glass composition of claim 1, wherein N₃ is equal or greater than 85%, wherein N₃ is defined as follows:
$${N}_{3} = ( \frac{B {O}_{3}}{B {O}_{3} + B {O}_{4}} ) .$$

5. The glass composition of claim 1, wherein the aluminum oxide is present in an amount ranging from about 30 mol % to about 45 mol %.

6. The glass composition of claim 1, wherein at least 30 mol % of the aluminum oxide is in five-coordination (AlO₅).

7. The glass composition of claim 1, wherein the rare earth metal oxide is yttrium oxide, lanthanum oxide, or a combination thereof, wherein the rare earth metal oxide ranges from about 5% to about 15% by mole.

8. The glass composition of claim 1, wherein the magnesium oxide ranges from about 5% to about 15% by mole.

9. The glass composition of claim 1, wherein the amounts of each of the oxides are selected so that the glass composition has a density ranging from about 2.50 to about 3.50 g/cm³.

10. The glass composition of claim 1, wherein the amounts of each of the oxides are selected so that the glass composition has a coefficient of thermal expansion (CTE) ranging from about 5.0 to about 6.0 ppm/K.

11. The glass composition of claim 1, wherein the amounts of each of the oxides are selected so that the glass composition has a transmission of equal or greater than 80% at a thickness ranging from about 1 mm to about 2 mm.

12. The glass composition of claim 1, wherein the amounts of each of the oxides are selected so that the glass composition has Youngs modulus ranging from about 90 to about 140 GPa.

13. The glass composition of claim 1, wherein the amounts of each of the oxides are selected so that the glass composition has Poisson's ratio ranging from about 0.20 to about 0.40.

14. The glass composition of claim 1, wherein the amounts of each of the oxides are selected so that the glass composition has a refractive index ranging from about 1.40 to about 1.80.

15. The glass composition of claim 1, wherein the amounts of each of the oxides are selected so that the glass composition has a Vickers hardness of equal or greater than 7.0 GPa at 200 gf load.

16. The glass composition of claim 1, wherein the amounts of each of the oxides are selected so that the glass composition has a crack resistance equal or greater than 25 N or 2.55 kgf, wherein the crack resistance corresponds to the load at which 50% crack probability is recorded.

17. An article of manufacture comprising the glass composition of claim 1.

18. A method of manufacturing the glass or glass ceramic composition of claim 1, comprising:
(a) heating at a temperature ranging from about 1300 to about 1700° C. a mixture comprising a rare earth metal oxide, magnesium oxide, aluminum oxide, boron oxide, and silicon oxide, wherein the silicon oxide is present in an amount ranging from about 10% to about 50% by mole in the total amount of the oxides and wherein the molar ratio of magnesium oxide to aluminum oxide (MgO:Al₂O₃) is less than 1;
and (b) quenching the melt in a desired shape and size.

19. The method of claim 18, further comprising quenching the melt between two metallic plates.

20. The method of claim 19, further comprising annealing the glass at temperatures lower than, equal to or higher than its glass transition temperature.
